(19) United States
(12) Patent Application Publication
(10) Pub. No.: US 2013/0040700 A1
(43) Pub. Date: Feb. 14, 2013

(54) IMAGE CAPTURE DEVICE AND IMAGE CAPTURE METHOD

(71) Applicant: Tokuhiro Nishikawa, Tokyo (JP)

(72) Inventor: Tokuhiro Nishikawa, Tokyo (JP)

(73) Assignee: Sony Corporation, Tokyo (JP)

(21) Appl. No.: 13/553,938

(22) Filed: Jul. 20, 2012

(30) Foreign Application Priority Data
Aug. 12, 2011 (JP) 2011-176498

(51) Int. Cl. G09G 5/377; H04N 5/225

(52) U.S. Cl. 455/556.1; 348/333.02; 348/E05.024

(57) ABSTRACT

An image capture apparatus configured to assist the user to obtain at least one image including a first image. The image capture apparatus comprises at least one processor configured to produce a first superimposed image by superimposing first navigation information with the first image at least in part by using first composition data associated with the first image and reference composition data associated with a reference image, and at least one display configured to display the first superimposed image. The first composition data comprises shooting angle information and/or angle-of-view information of the image capture apparatus when the image capture apparatus obtained the first image.

### BACKGROUND

Some embodiments described in the present application relate to an image capture apparatus and an image capture method which are applicable to image-capture functions of digital cameras and mobile electronic apparatuses, such as mobile phones.

Hitherto, providing assistance to users so that they can take good pictures has been conceived. For example, Japanese Unexamined Patent Application Publication No. 2009-239397 discloses a technology in which a position detection function is provided and, when any posted picture captured in the vicinity of the current position is available, the posted picture and composition information thereof are received from a server. Guide information for guiding the user to move to the shooting position of the posted picture is generated and is displayed on a display section with an arrow and numeric values. In accordance with the guide information, the user is guided to the shooting position.

When the user reaches the shooting position in accordance with the guide information, a prompt for shooting is given. That is, an actual image to be captured is displayed on a finder with a transparent image of a reference picture being superimposed thereon. The user makes fine adjustment so that the actual image to be captured matches the reference picture. With this arrangement, even when the user is not familiar with how to take a picture or even when the user is taking a picture at an unfamiliar place, it is possible to take a picture with a more preferable composition.

### SUMMARY

In general, the shooting point and the composition for shooting are elements that are inseparable from each other, and all three elements, i.e., the position, the attitude, and the angle of view of the camera, are involved to define a specific composition. When the flow of the shooting is considered from the standpoint of the user of the camera, three steps are taken. That is, first, the user moves to the shooting point, then determines the direction in which the camera is aimed, and lastly determines the angle of view for shooting by zoom adjustment and so on. Thus, for example, when the user convenience is taken into account, it is important that the three-step guidance for a recommended composition for shooting be seamlessly given to the user.

However, in the technology disclosed in Japanese Unexamined Patent Application Publication No. 2009-239397, the screen display is switched between the flow of the guidance for guiding the user up to the shooting point and a prompt for shooting after the user reaches the shooting point. Thus, there is a problem in that the technology lacks consistency in giving information to the user and does not provide a shooting guide that enables sufficiently intuitive operations. In addition, in the technology disclosed in Japanese Unexamined Patent Application Publication No. 2009-239397, since the image data of the reference picture is stored, there is a problem in that the amount of data of the reference image increases.

Accordingly, it is desirable to provide an image capture apparatus and an image capture method which are capable of giving easy-to-understand intuitive guidance through a coherent user interface without switching images displayed and are capable of reducing the amount of data processed.

With this arrangement, guidance for steps of moving to the shooting point, determining the shooting direction, and determining the angle of view can be seamlessly given to the user without switching images. Accordingly, it is possible to give guidance that is easy to understand for the user. In addition, since no reference picture data is used, it is possible to suppress an increase in the amount of data.

Accordingly, in some embodiments, an image capture apparatus configured to obtain at least one image including a first image is disclosed. The image capture apparatus comprises at least one processor configured to produce a first superimposed image by superimposing first navigation information with the first image at least in part by using first composition data associated with the first image and reference composition data associated with a reference image, and at least one display configured to display the first superimposed image. The first composition data comprises shooting angle information and/or angle-of-view information of the image capture apparatus when the image capture apparatus obtained the first image.

In some embodiments, a method is disclosed for assisting a user obtain at least one image, including a first image, with an image capture apparatus. The method comprises producing, with the image capture apparatus, a first superimposed image by superimposing first navigation information with the first image at least in part by using first composition data associated with the first image and reference composition data associated with a reference image; and displaying the first superimposed image, wherein the first composition data comprises shooting angle information and/or angle-of-view information of the image capture apparatus when the image capture apparatus obtained the first image.

In some embodiments at least one computer-readable storage medium is disclosed. The at least one computer-readable storage medium stores processor-executable instructions that, when executed by an image capture apparatus, cause the image capture apparatus to perform a method for assisting a user obtain at least one image including a first image. The method comprises producing, with the image capture apparatus, a first superimposed image by superimposing first navigation information with the first image at least in part by using first composition data associated with the first image and reference composition data associated with a reference image, and displaying the first superimposed image. The first composition data comprises shooting angle information and/or angle-of-view information of the image capture apparatus when the image capture apparatus obtained the first image.

The foregoing is a non-limiting summary of the invention, which is defined by the attached claims.

### BRIEF DESCRIPTION OF THE DRAWINGS

FIGS. 1A and 1B are perspective views illustrating the external appearance of an image capture apparatus according to an embodiment of the present disclosure;

FIG. 2 is a block diagram of the image capture apparatus according to the embodiment of the present disclosure;

FIG. 3 is a block diagram of the configuration of a portion of the image capture apparatus according to the embodiment of the present disclosure;

FIGS. 4A to 4F are schematic diagrams illustrating an overview of a display object;

FIG. 5A is a schematic view illustrating the positional relationship between the image capture apparatus according to the embodiment of the present disclosure and a subject and FIG. 5B is a schematic view illustrating an image displayed on the screen of an LCD of the image capture apparatus according to the embodiment of the present disclosure;

FIG. 6A is a schematic view illustrating the positional relationship between the image capture apparatus according to the embodiment of the present disclosure and the subject and FIG. 6B is a schematic view illustrating an image displayed on the screen of the LCD of the image capture apparatus according to the embodiment of the present disclosure;

FIG. 7A is a schematic view illustrating the positional relationship between the image capture apparatus according to the embodiment of the present disclosure and the subject and FIG. 7B is a schematic view illustrating an image displayed on the screen of the LCD of the image capture apparatus according to the embodiment of the present disclosure;

FIG. 8A is a schematic view illustrating the positional relationship between the image capture apparatus according to the embodiment of the present disclosure and the subject and FIG. 8B is a schematic view illustrating an image displayed on the screen of the LCD of the image capture apparatus according to the embodiment of the present disclosure;

FIG. 9A is a schematic view illustrating the positional relationship between the image capture apparatus according to the embodiment of the present disclosure and the subject and FIG. 9B is a schematic view illustrating an image displayed on the screen of the LCD of the image capture apparatus according to the embodiment of the present disclosure;

FIG. 10A is a schematic view illustrating the positional relationship between the image capture apparatus according to the embodiment of the present disclosure and the subject and FIG. 10B is a schematic view illustrating an image displayed on the screen of the LCD of the image capture apparatus according to the embodiment of the present disclosure;

FIG. 11 is a schematic view illustrating another example of an image displayed on the screen of the LCD of the image capture apparatus according to the embodiment of the present disclosure;

FIGS. 12A and 12B are schematic views each illustrating yet another example of an image displayed on the screen of the LCD of the image capture apparatus according to the embodiment of the present disclosure;

FIG. 13 illustrates the flow of viewing-pipeline processing for generating display objects in the image capture apparatus according to the embodiment of the present disclosure; and

FIG. 14 is a flowchart illustrating the flow of processing for the image capture apparatus according to the embodiment of the present disclosure.

### DETAILED DESCRIPTION OF EMBODIMENTS

Hereinafter, some illustrative preferred embodiments will be described below. The scope of the present disclosure, however, is not limited to the embodiments described below, unless otherwise specifically stated.

### One Example of Image Capture Apparatus

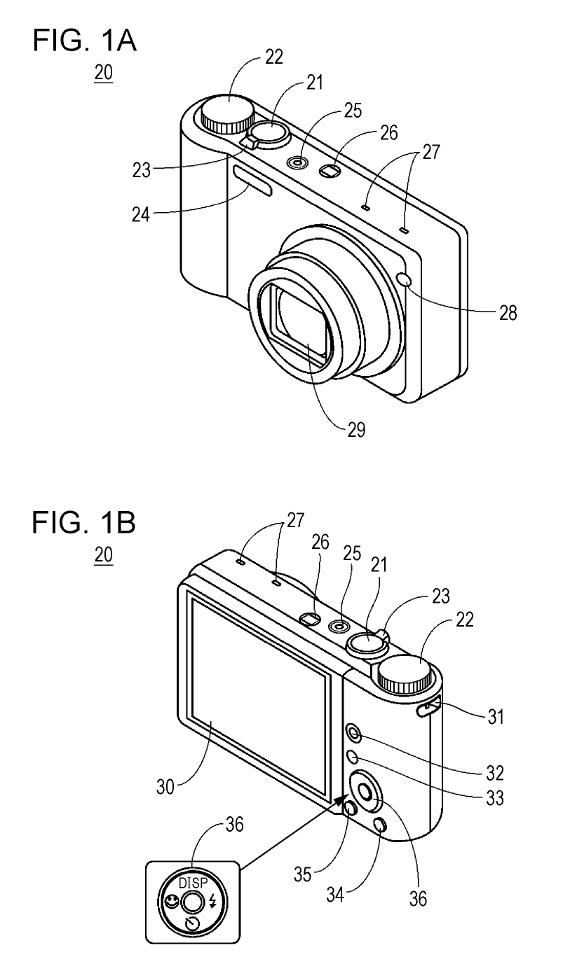

One embodiment of the present disclosure will now be described. One example of an image capture apparatus to which the present disclosure is applicable will first be described with reference to FIGS. 1A and 1B. FIG. 1A is a front view of an image capture apparatus 20 and FIG. 1B is a rear view of the image capture apparatus 20. The image capture apparatus 20 has a shutter button 21, a mode dial 22, a zoom lever 23, a flash 24, a power button 25, a continuous shooting button 26, a microphone 27, a self-timer button 28, and a lens 29. A user rotates the mode dial 22 to select a function he or she wishes to operate. For example, the mode dial 22 allows switching for the functions of an auto-shooting mode in which auto-setting shooting can be performed, a manual exposure shooting, a program auto shooting, a moving-image shooting, and so on.

The image capture apparatus 20 has, at its rear surface, an LCD (liquid crystal display) 30, a strap attachment portion 31, a moving-image button 32, a playback button 33, a deletion button 34, a menu button 35, and a control button 36. As illustrated in a magnified view in FIG. 1B, the control button 36 has an execute button, located at its center, and upper, lower, left, and right selection buttons. For example, when the upper selection button is pressed, a screen-display setting representation is displayed on the screen of the LCD 30. For example, when the right selection button (i.e., the selection button located at the right side in the drawing) is pressed, a flash-setting representation is displayed on the screen of the LCD 30. The image capture apparatus 20 illustrated in FIGS. 1A and 1B is merely one example and the present disclosure is applicable to image-capture functions of other configurations, for example, a smart phone, a tablet computer, etc.

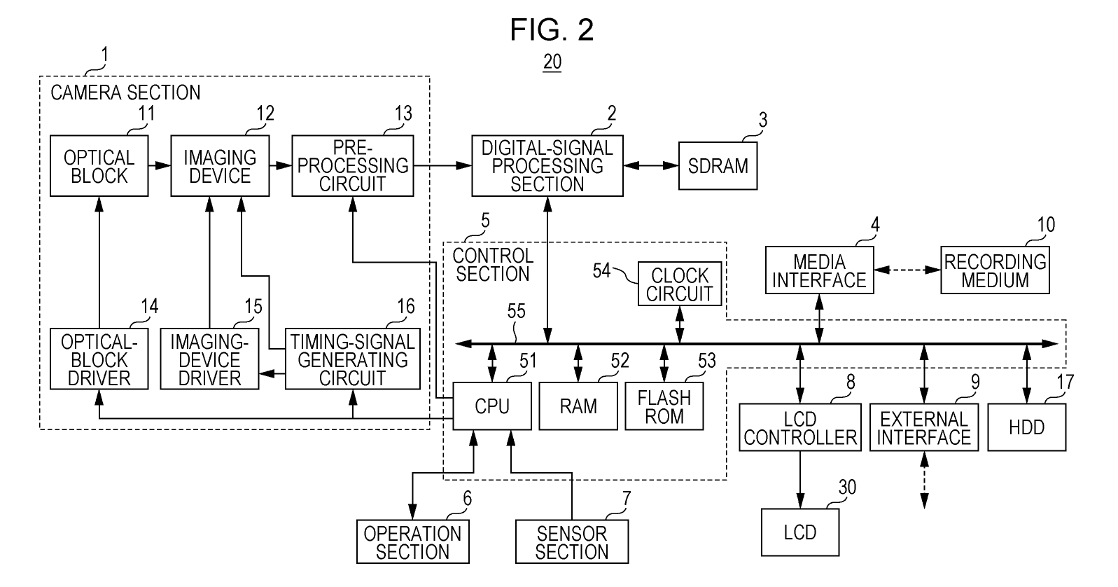

As illustrated in FIG. 2, the image capture apparatus 20 includes a camera section 1, a digital-signal processing section 2, an SDRAM (synchronous dynamic random access memory) 3, a media interface 4, a control section 5, an operation section 6, and a sensor section 7. The image capture apparatus 20 further includes an LCD controller 8 and an external interface 9. A recording medium 10 is removably attached to the media interface 4. In addition, the image capture apparatus 20 may have a hard disk drive (HDD) 17, which is a large-capacity recording medium, in order to store image files.

The recording medium 10 is, for example, a memory card using a semiconductor memory or the like. Instead of the memory card, the recording medium 10 may be implemented by, for example, a hard disk device, a magnetic disk, or an optical recording medium, such as a recordable DVD (digital versatile disc) or recordable CD (compact disc).

The camera section 1 has an optical block 11, an imaging device 12, a pre-processing circuit 13, an optical-block driver 14, an imaging-device driver 15, and a timing-signal generating circuit 16. Examples of the imaging device 12 include a CCD (charge coupled device) and a CMOS (complementary metal oxide semiconductor). The optical block 11 has a lens, a focusing mechanism, a shutter mechanism, a diaphragm (iris) mechanism, and so on.

The control section 5 may be a microcomputer to control the individual sections of the image capture apparatus 20 according to this embodiment. The control section 5 may have a configuration in which a CPU (central processing unit) 51, a RAM (random access memory) 52, a flash ROM (read only memory) 53, and a clock circuit 54 are interconnected through a system bus 55. The RAM 52 is primarily used as a work area for temporarily storing results obtained during processing. The flash ROM 53 stores various programs executed by the CPU 51, data used for processing, and so on. The clock circuit 54 has a function for providing the current year, month, and day, the current day of week, the current time, shooting date and time, and so on and a function for adding date-and-time information, such as the shooting date and time, to a captured-image file.

During shooting, the optical-block driver 14 generates a drive signal for driving the optical block 11, in accordance with control performed by the control section 5, and supplies the drive signal to the optical block 11 to operate the optical block 11. In response to the drive signal supplied from the optical-block driver 14, the optical block 11 controls the focusing mechanism, the shutter mechanism, and the diaphragm mechanism to capture an image of a subject. The optical block 11 then supplies the subject image to the imaging device 12. The optical block 11 may have a replaceable lens device. For example, the lens device has a microcomputer therein to transmit information, such as the type of lens device and the current focal length, to the CPU 51.

The imaging device 12 photoelectrically transforms the subject image supplied from the optical block 11 and then outputs the resulting subject image. In response to a drive signal from the imaging-device driver 15, the imaging device 12 operates to capture the subject image. On the basis of a timing signal from the timing-signal generating circuit 16 controlled by the control section 5, the imaging device 12 supplies the captured subject image to the pre-processing circuit 13 as an electrical signal.

Under the control of the control section 5, the timing-signal generating circuit 16 generates a timing signal for providing predetermined-timing information. On the basis of the timing signal from the timing-signal generating circuit 16, the imaging-device driver 15 generates the drive signal to be supplied to the imaging device 12.

The pre-processing circuit 13 performs CDS (correlated double sampling) processing on a supplied captured-image signal to improve the S/N (signal-to-noise) ratio, performs AGC (automatic gain control) processing to control the gain, and performs A/D (analog-to-digital) conversion to generate captured-image data, which includes a digital signal.

The pre-processing circuit 13 supplies the digital captured-image data to the digital-signal processing section 2. The digital-signal processing section 2 performs camera-signal processing on the captured-image data. Examples of the camera-signal processing include AF (auto focus) processing, AE (auto exposure) processing, and AWB (auto white balance) processing. Image data resulting from the camera-signal processing is compressed by a predetermined compression system, the compressed image data is supplied to the recording medium 10, attached to the media interface 4, and/or to the hard disk drive 17 through the system bus 55 and is recorded to the recording medium 10 and/or the hard disk drive 17 as an image file that complies with, for example, a DCF (Design rule for Camera File system) standard.

An intended piece of the image data recorded on the recording medium 10 is read from the recording medium 10 via the media interface 4 in accordance with an operation input received from the user via the operation section 6. The read piece of image data is then supplied to the digital-signal processing section 2. The operation section 6 includes, for example, a lever, a dial, and various buttons, such as a shutter release button. The LCD 30 may be implemented as a touch panel so that the user can perform an input operation by touching/pressing the screen with his or her finger or a pointing device.

The digital-signal processing section 2 performs decompression processing (extraction processing) on the compressed image data, read from the recording medium 10 and supplied via the media interface 4, and supplies the decompressed image data to the LCD controller 8 through the system bus 55. The LCD controller 8 generates a display image signal by using the image data and supplies the generated display image signal to the LCD 30. As a result, an image corresponding to the image data recorded on the recording medium 10 is displayed on the screen of the LCD 30. In addition, under the control of the control section 5 and the LCD controller 8, graphics and text for a menu and so on can be displayed on the screen of the LCD 30. An image may be displayed in a format according to a display-processing program recorded in the flash ROM 53.

The image capture apparatus has the external interface 9, as described above. The image capture apparatus 20 may be connected to, for example, an external personal computer via the external interface 9. In such a case, upon receiving image data from the personal computer, the image capture apparatus 20 can record the image data to the recording medium loaded thereinto. Also, the image capture apparatus 20 can supply image data recorded on the recording medium, loaded thereinto, to the external personal computer.

A communication module may also be connected to the external interface 9 to connect to a network, such as the Internet. In such a case, the image capture apparatus can obtain various types of image data or other information through the network and can record the image data or the information to the loaded recording medium. Alternatively, the image capture apparatus 20 can transmit data, recorded on the loaded recording medium, to intended equipment through the network.

The image capture apparatus 20 can also read and reproduce information regarding the image data, obtained from the external personal computer or through the network and recorded on the recording medium, and can display the information on screen of the LCD 30.

The external interface 9 may also be provided as a wired interface, such as an IEEE (Institute of Electrical and Electronics Engineers) 1394 interface or a USB (universal serial bus) interface, or may also be provided as a wireless interface utilizing light or radio waves. That is, the external interface 9 may be any of such wired and wireless interfaces. For example, through connection to an external computer apparatus (not illustrated) via the external interface 9, the image capture apparatus 20 can receive image data supplied from the computer apparatus and can record the received image data to the recording medium 10 and/or the hard disk drive 17. The image capture apparatus 20 can also supply the image data, recorded on the recording medium 10 and/or the hard disk drive 17, to the external computer device or the like.

After capturing an image (a still image or a moving image) of a subject, the image capture apparatus 20 can record the subject image to the loaded recording medium 10 and/or the hard disk drive 17. In addition, the image data recorded on the recording medium 10 and/or the hard disk drive 17 can be read and a corresponding image can be displayed for arbitrary viewing and editing. An index file for managing the image data is recorded in a specific area of the recording medium 10 and/or the hard disk drive 17.

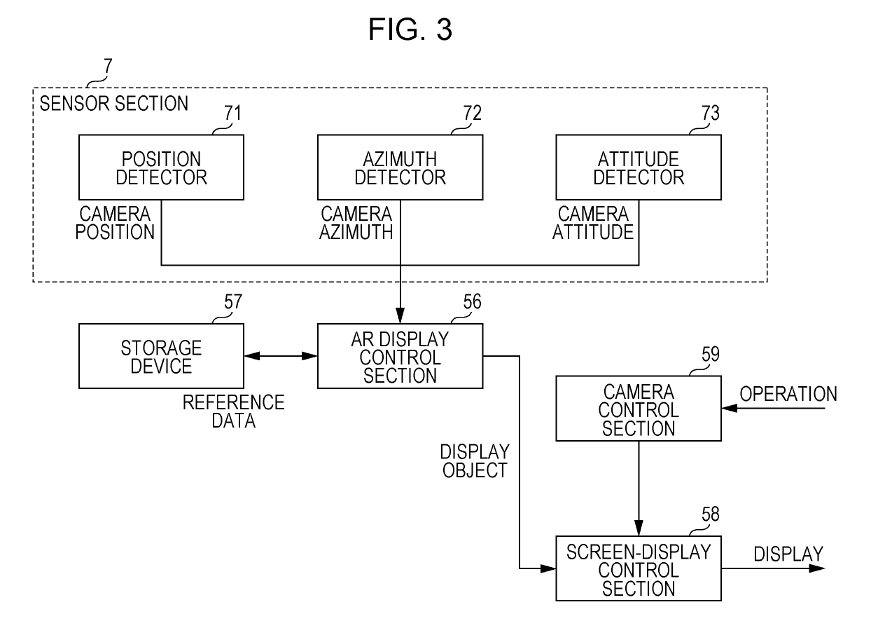

As illustrated in FIG. 3, the sensor section 7 has a position detector 71, an azimuth detector 72, and an attitude detector 73. For example, by using a GPS (global positioning system), the position detector 71 detects the current position of the image capture apparatus 20 to obtain position data of the current position. For example, by using an electronic compass as a geomagnetic sensor, the azimuth detector 72 obtains azimuth data indicating the current shooting direction (in a horizontal plane) of the image capture apparatus 20. For example, by using an acceleration sensor, the attitude detector 73 obtains attitude data indicating the current shooting direction (in a vertical plane) of the image capture apparatus 20. The azimuth data and the attitude data specify a shooting angle.

The position data, the azimuth data, and the attitude data are supplied from the sensor section 7 to an AR (augmented reality) display control section 56. The AR display control section 56 is one function of the control section 5. The AR is a technology that allows a virtual object to be displayed on the screen of the LCD 30 with the virtual object being superimposed on an image (a captured image) in the real-life environment. The configuration (illustrated in FIG. 3) including the AR display control section 56 is described later.

Now, an operation of the above-described image capture apparatus will be briefly described. The imaging device 12 receives light, photoelectrically converts the light into a signal, and supplies the signal to the pre-processing circuit 13. The pre-processing circuit 13 performs the CDS processing and AGC processing on the signal to convert it into a digital signal and supplies the digital signal to the digital-signal processing section 2. The digital-signal processing section 2 performs image-quality correction processing on image data and supplies the resulting image data to the control section 5 as image data of a through-the-camera image. The image data is then supplied from the control section 5 to the LCD controller 8 and the through-the-camera image is displayed on the screen of the LCD 30.

With this arrangement, the user can adjust the angle of view while viewing the through-the-camera image displayed on the screen of the LCD 30. As described below, in the present disclosure, the AR is used to display virtual objects on the screen of the LCD 30 on which a subject image is displayed. By displaying the virtual objects, the image capture apparatus 20 is adapted to guide the user for taking a recommended picture.

When the shutter button of the operation section 6 is pressed, the CPU 51 outputs a control signal to the camera section 1 to operate the shutter of the optical block 11. In response, the digital-signal processing section 2 processes image data (record-image data) for one frame, the image data being supplied from the pre-processing circuit 13, and then stores the image data in the SDRAM 3. The digital-signal processing section 2 further compresses and encodes the record-image data. The resulting encoded data may be stored on the hard disk drive 17 and may also be stored on the recording medium 10 through the system bus 55 and the media interface 4.

With respect to a still-image data, the CPU 51 obtains the shooting date and time from the clock circuit 54, adds the shooting date and time to the still-image data, and stores the resulting image data on the hard disk drive 17 and/or the recording medium 10. In addition, the position data, the azimuth data, and the attitude data obtained from the sensor section 7 may also be added to the obtained image data. Additionally, with respect to a still image, data of a reduced-size image (a thumbnail) thereof is generated and is stored on the hard disk drive 17 and/or the recording medium 10 in association with the original still image.

On the other hand, when the record-image data stored in the hard disk drive 17 and the recording medium 10 is to be reproduced, the record-image data selected by the CPU 51 is read to the SDRAM 3 in accordance with an operation input from the operation section 6. The digital-signal processing section 2 then decodes the record-image data. The decoded image data is then supplied to the LCD 30 via the LCD controller 8 and a reproduced image is displayed on the screen of the LCD 30.

### Virtual Objects

In the present disclosure, the image capture apparatus 20 has a function for guiding a photographing person (user) for taking a good picture. For the guidance, the AR is used to display virtual objects on the screen of the LCD 30 on which a subject image is displayed. The virtual objects change like real-life subjects, in accordance with the shooting position, the shooting angle, and the angle of view. The virtual objects include a first display object and a second display object. The image capture apparatus 20 is adapted to detect the orientation of the camera with high responsiveness in order to present the virtual objects so that they correspond to the real-life environment image obtained by the image capture apparatus 20.

The AR display control section 56 generates information of the first and second display objects. As described above, the signal output from the sensor section 7 is supplied to the AR display control section 56. In addition, composition data is supplied from a storage device 57 (illustrated in FIG. 3) to the AR display control section 56. The storage device 57 stores reference-position data (e.g., longitude and latitude information) indicating recommended shooting points and recommended composition data with respect to recommended pictures of sceneries at sightseeing spots, buildings, and so on. Each piece of the composition data includes reference angle data regarding a shooting angle and reference angle-of-view data regarding the angle of view.

The reference position data, the reference angle data, and the reference angle-of-view data (these data may be collectively referred to as “reference data” hereinafter) are pre-stored in the storage device 57. For example, the reference data may be obtained through the Internet and be stored in the storage device 57. For example, when the user sets the shooting mode to a guide mode, the reference data of pictures taken in the vicinity of the current position of the image capture apparatus 20 (the user) are searched for and the found reference data is read from the storage device 57 and is supplied to the AR display control section 56.

The AR display control section 56 uses the current data supplied from the sensor section 7 and the reference data to generate display objects corresponding to the first and second display objects. The display objects are supplied to a screen-display control section 58, which generates a display signal for display on the screen of the LCD 30. In addition, a signal resulting from the user's camera operation is supplied to a camera control section 59 and is subjected to control for image capture. In addition, the angle-of-view information regarding the angle of view is supplied to the screen-display control section 58.

The angle of view refers to a range in which the shooting can be performed through a lens and varies according to the focal length of the lens. Typically, the angle of view increases as the focal length decreases and the angle of view decreases as the focal length increases. Thus, even when an image of the same subject is captured, a difference in the angle of view causes the shooting range to vary and also causes a composition at the angle of view for the shooting to vary. In addition, since the angle of view is affected by not only the focal length but also the lens characteristics, information of the lens characteristics is also used as the angle-of-view information. Additionally, even when the focal length is the same, the angle of view increases as the area of the imaging device increases, and the angle of view decreases as the area of the imaging device decreases. The area of the imaging device has a constant value according to the model type of the image capture apparatus. The angle of view has three types of information, i.e., a horizontal angle of view, a vertical angle of view, and a diagonal angle of view. All or part of the information of the angles may be used. The angle-of-view information is expressed in units of degrees.

Considering the factors described above, the angle-of-view information, which is calculated from the focal length, the lens characteristics, and other information, is supplied from the camera control section 59 to the screen-display control section 58. In addition, on the basis of the data, such as the focal length and the lens characteristics, supplied from the camera control section 59, the screen-display control section 58 determines the angle-of-view information. On the basis of the relationship between the angle of view used for the shooting guidance and the current angle of view, a display object indicating the angle of view used for the shooting guidance is generated.

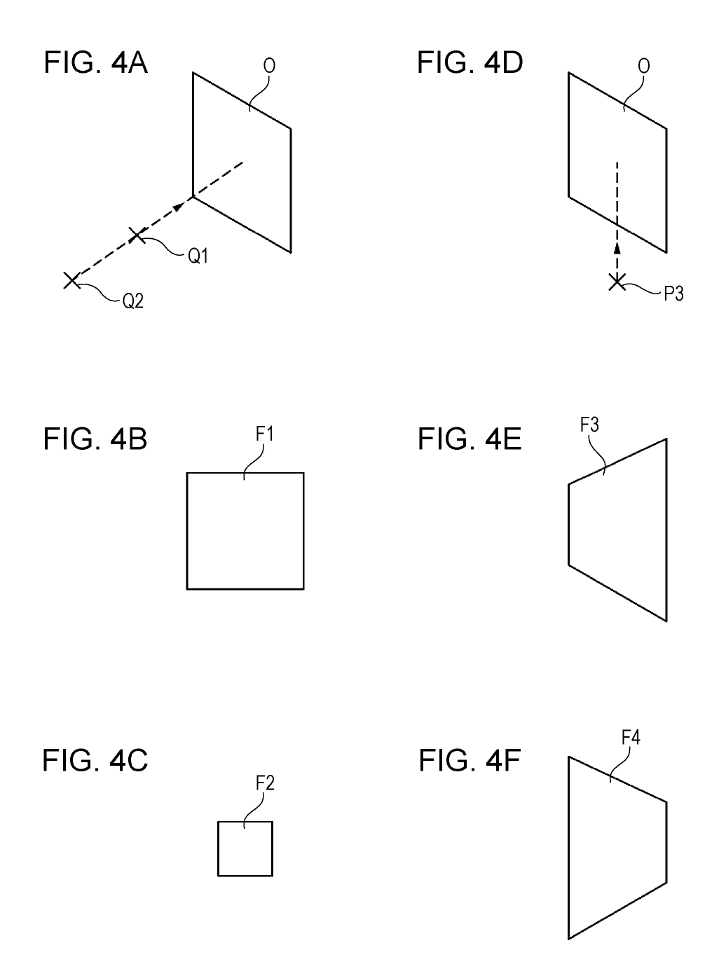

Now, display objects generated by the AR display control section 56 will be briefly described with reference to FIGS. 4A to 4F. For simplicity of description, the area and the focal length of the imaging device are assumed to be constant. It is assumed that the virtual object is a subject O having a rectangular frame shape, by way of example. It is further assumed that, as illustrated in FIG. 4A, an image of the subject O is captured at a position Q1. When the shooting position Q1 and the shooting angle respectively match the reference-position data and the reference-angle data stored in the storage device 57, a square frame F1 is generated as a display object as illustrated in FIG. 4B. When an image of the subject O is captured at a farther shooting position Q2 at the same shooting angle, a smaller square frame F2 is generated as a display object as illustrated in FIG. 4C. Upon display of the frame F2, it can be understood that the user is too far from the subject as compared to a recommended position.

When an image of the subject O is captured at a distance equal to the distance of the reference position data and at a different shooting angle as illustrated in FIG. 4D, a distorted frame F3 as illustrated in FIG. 4E is generated as a display object. When the shooting angle is tilled in an opposite direction, a distorted frame F4 as illustrated in FIG. 4F is generated as a display object. The user adjusts the shooting angle so that the shape of the frame has no distortion. Thus, the frame is a graphics obtained by transforming a three-dimensional (3D) subject into a two-dimensional (2D) display plane. With the size and the shape of the frame, the user is guided to move to a recommended shooting position at a recommended shooting angle.

That is, since an actual subject is displayed on the screen of the LCD 30 with the virtual object (the frame) being superimposed thereon, it is possible to take a picture that is equivalent to the recommended image by setting the shooting position and the shooting angle so that the frame has an undistorted shape, such as a square, and the size thereof becomes the largest on the screen or the frame goes out of and disappears from the screen. Since the virtual display object is, for example, a graphics obtained by transforming a three-dimensional object into a two-dimensional representation, the user can easily recognize the current shooting position and shooting angle.

### Specific Example of Display Object

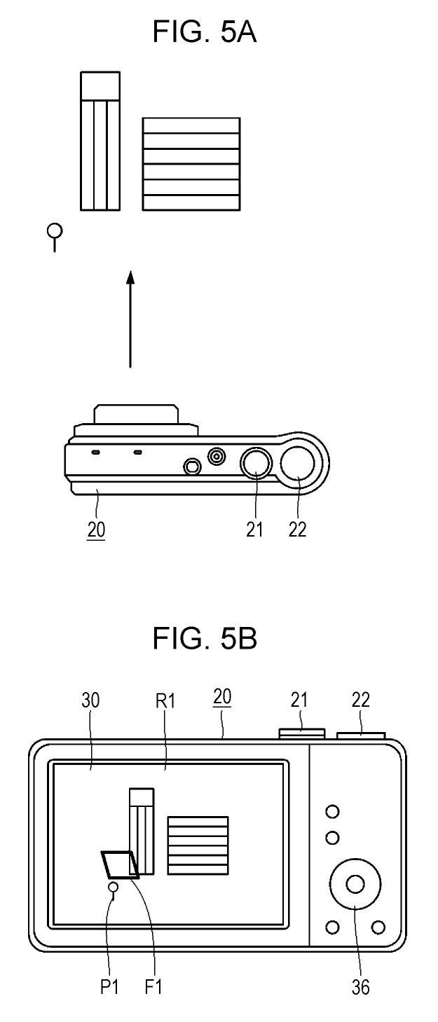

The present disclosure will further be described below. As illustrated in FIG. 5A, an image of an actual subject, for example, buildings, is captured with the image capture apparatus 20. In this case, as illustrated in FIG. 5B, a pin P1, which is a first display object, and a frame F1, which is a second display object, in addition to a subject image R1 are displayed on the screen of the LCD 30 of the image capture apparatus 20. The pin P1 and the frame F1 represent one composition for shooting. Although the mark of the pin illustrated in FIG. 5A does not exist in the real-life scenery, the mark is rendered so that the current position of the image capture apparatus 20 can be easily located. The pin P1 in the displayed image specifies a position (a shooting spot) where the photographing person is actually supposed to be. The frame F1 specifies the direction in which the image capture apparatus 20 is to be aimed and the angle of view. The shooting position, the direction in which the image capture apparatus 20 is to be aimed, and the angle of view define a composition. The reference data (shooting positions and compositions) stored in the storage device 57 indicates shooting points where pictures with “preferable compositions” can be taken, for example, sightseeing spots.

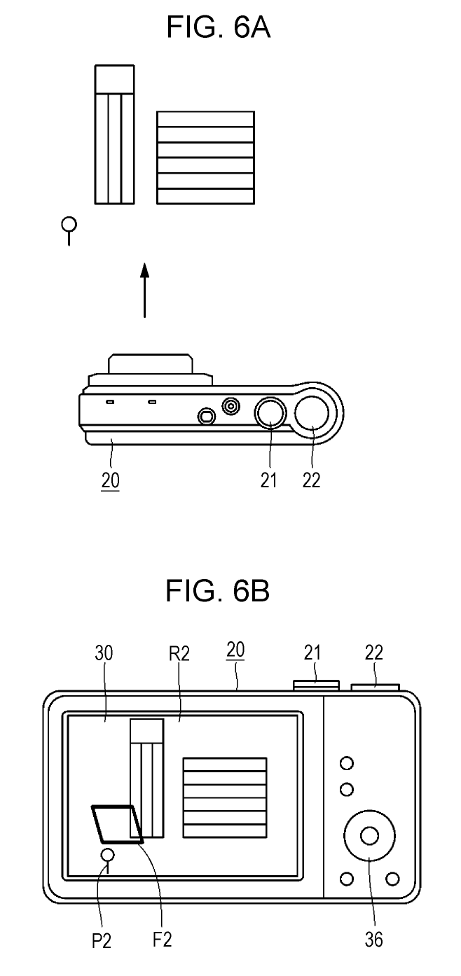

When the photographing person moves closer to the subject than the shooting position illustrated in FIG. 5A, as illustrated in FIG. 6A, a subject image R2, a pin P2, and a frame F2 are displayed on the screen of the LCD 30 of the image capture apparatus 20, as illustrated in FIG. 6B. Those images are enlarged by an amount corresponding to the reduced distance to the subject. Since the shooting angle and the angle of view with respect to the subject have not been changed, the frame F2 has an enlarged shape of the frame F1. The position information, the azimuth information, the attitude information, and the angle-of-view information of the image capture apparatus 20 are obtained at predetermined time intervals and are used to re-render the frame and the pin serving as display objects.

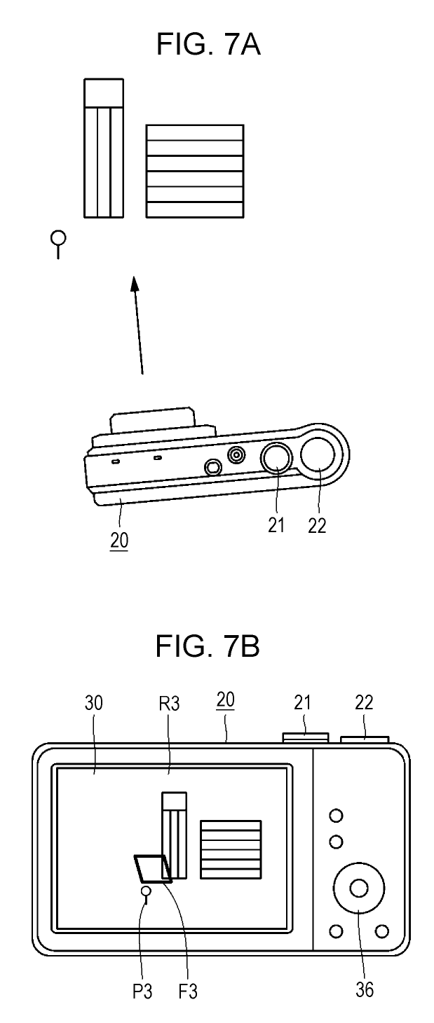

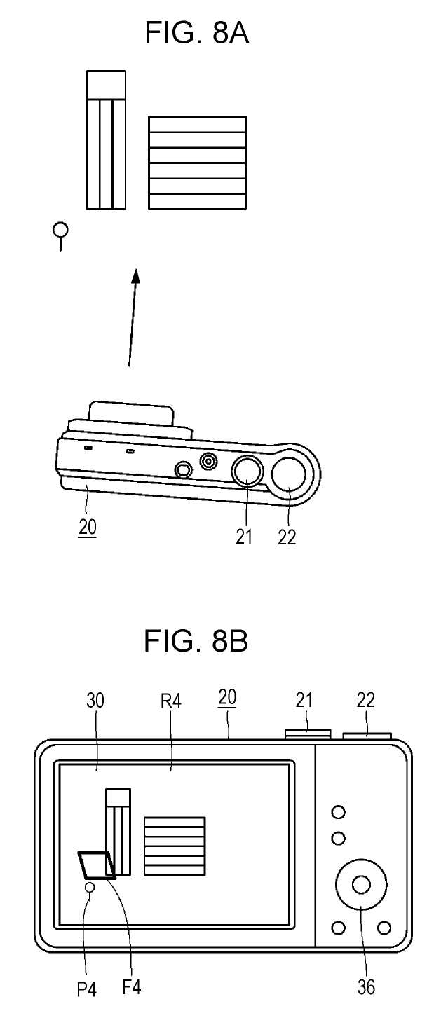

When the direction (the shooting direction) of the image capture apparatus 20 relative to the subject is changed leftward at the same shooting position as the shooting position illustrated in FIG. 5A, as illustrated in FIG. 7A, a subject image R3, a pin P3, and a frame F3 are displayed on the screen of the LCD 30 of the image capture apparatus 20 with their positions being moved rightward, as illustrated in FIG. 7B. When the direction (the shooting direction) of the image capture apparatus 20 relative to the subject is changed rightward at the same shooting position as the shooting position illustrated in FIG. 5A, as illustrated in FIG. 8A, a subject image R4, a pin P4, and a frame F4 are displayed on the screen of the LCD 30 of the image capture apparatus 20 with their positions shifting leftward, as illustrated in FIG. 8B.

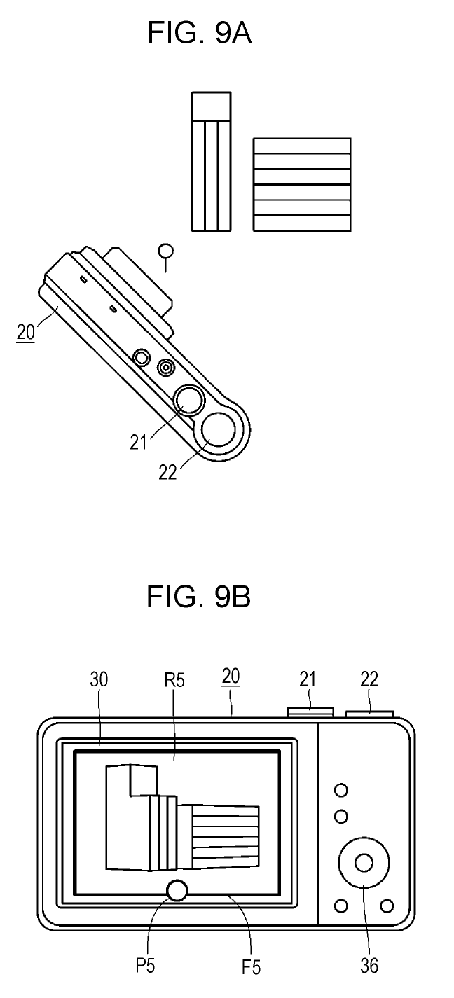

As described above, the pin and the frame displayed on the screen of the LCD 30 change in the same manner as the subject, as in the real-life environment, in response to the motion of the image capture apparatus 20. As illustrated in FIG. 9A, when the user moves closer to the recommended shooting point, an image illustrated in FIG. 9B is displayed on the screen of the LCD 30. In this case, since the shooting angle and the angle of view are substantially equal to the reference shooting angle and the reference shooting angle of view, respectively, a square frame F5 is displayed on the entire display screen. A subject image R5 is an image that is quite similar to the recommended captured image and a pin P5 is displayed so as to give guidance indicating that the recommended shooting point is slightly closer to the subject than the current position.

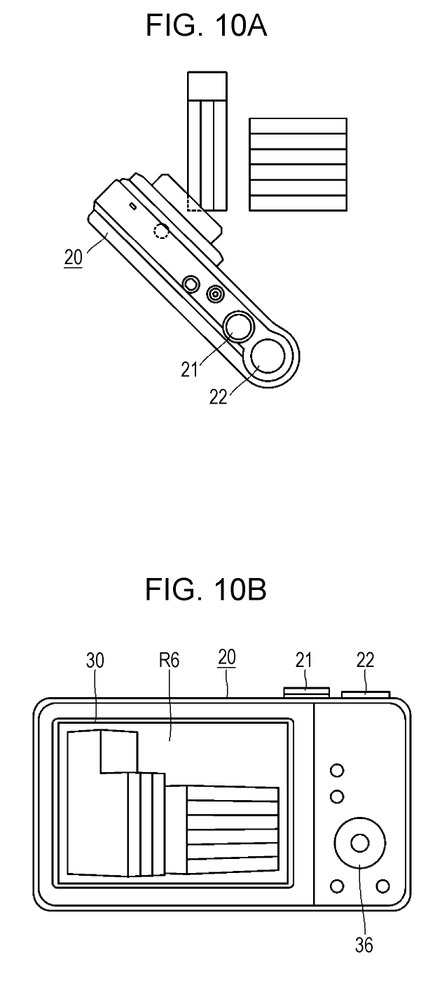

The user views the screen of the LCD 30 illustrated in FIG. 9B and moves a little closer to the subject. As a result, as illustrated in FIG. 10A, the image capture apparatus 20 reaches the position that matches the reference shooting position. In this case, an image as illustrated in FIG. 10B is displayed on the screen of the LCD 30. That is, the frame and the pin that have been displayed disappear and only a captured subject image R6 is displayed on the screen of the LCD 30. As a result of the disappearance of the frame and the pin from the screen of the LCD 30, the user can recognize that he or she has reached the reference shooting position, can recognize that the current azimuth and attitude of the image capture apparatus 20 match the reference shooting angle, and further can recognize that the current angle of view matches the reference angle of view. In this state, upon press of the shutter button 21, a picture with the recommended composition can be taken.

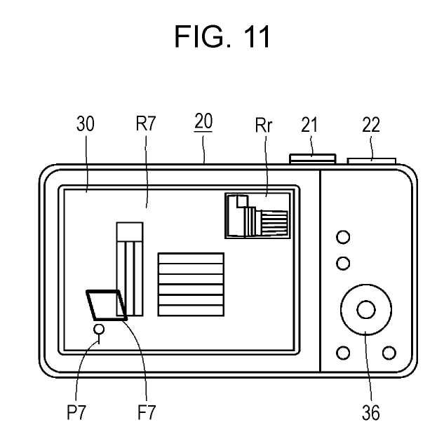

As illustrated in FIG. 11, in addition to a subject image R7, a frame F7, and a pin P7, a thumbnail (a reduced-size image) Rr of the recommended image captured at the reference shooting position, at the reference angle, and at the reference angle of view may also be displayed on the screen of the LCD 30. The user can set the shooting position, the shooting angle, and the angle of view by referring to the thumbnail as an example picture. Instead of the thumbnail, a semi-transparent image may be displayed as an example picture. With the thumbnail, the photographing person can recognize a composition of a picture that can be taken from the shooting point without actually moving to the shooting point. In addition, when the photographing person takes a picture while referring to the thumbnail, a more preferable composition can be reproduced with higher accuracy.

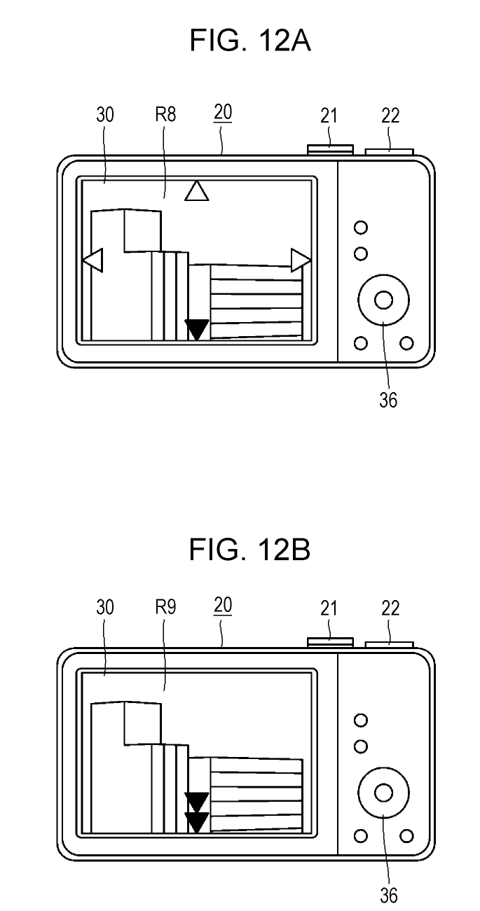

Additionally, in the present disclosure, when the shooting position, the shooting angle, and the angle of view match the reference shooting position, the reference shooting angle, and the reference angle of view, respectively, the frame F and the pin P disappear from the screen of the LCD 30, as illustrated in FIG. 10B. Consequently, there is a possibility that the user does not recognize that he or she has moved too closer to the subject than the reference shooting position. In order to avoid such a problem, when the user moves further closer to the subject after the frame disappears, a cursor or cursors indicating a direction toward the reference shooting position may be displayed superimposed on a subject image R8 or R9 as illustrated in FIG. 12A or 12B, to thereby notify the user.

As described above, when the user changes the direction in which the image capture apparatus 20 is to be aimed, signals output from the azimuth detector 72 and the attitude detector 73 vary. The positions at which the pin and the frame are displayed are varied according to the values of the output signals. When the user changes the azimuth of the image capture apparatus 20 to the left by 10 degrees as illustrated in the example of FIG. 7A, the display objects on the screen of the LCD 30 shift to the right side by an amount corresponding to 10 degrees as illustrated in FIG. 7B. Similarly, when the image capture apparatus 20 is aimed upward, all of the display objects on the screen of the LCD 30 shift downward. The display objects also change depending on the angle of view of the image capture apparatus 20. For example, for a large angle of view, the display objects are displayed with a reduced size, and for a small angle of view, the display objects are displayed with an increased size.

### One Example of Processing of Display Transformation

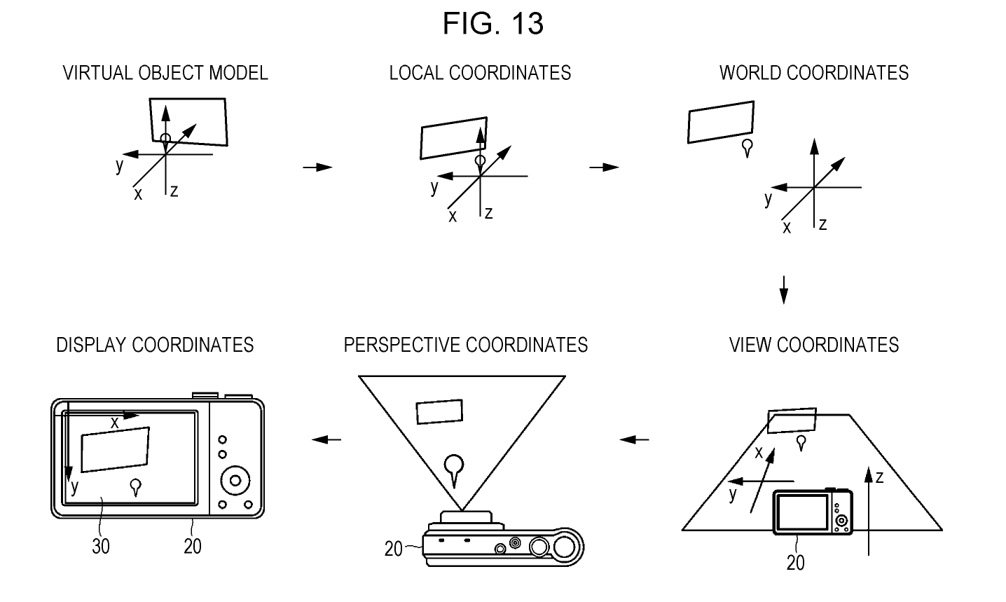

This display transformation may be processed in real time without inconsistency by, for example, viewing-pipeline processing widely used in three-dimensional games and so on. FIG. 13 illustrates the flow of the viewing-pipeline processing performed by the AR display control section 56. The viewing-pipeline processing refers to a series of coordinate transformations for stereoscopically displaying, in a two-dimensional plane, a three-dimensional model represented by three-dimensional data. As a result of the processing, the user can have a sensation as if the virtual pin and the virtual frame were present in the real-life space, by viewing the scenery through the image capture apparatus 20.

FIG. 13 illustrates the flow of the viewing-pipeline processing. First, virtual object models are created in local coordinates. That is, a pin indicating a shooting position and a frame indicating a subject are created as virtual object models. Next, coordinate transformation is performed in accordance with the shooting angle relative to the virtual object models, so that virtual objects are defined in the local coordinates. During the transformation of the virtual object models into the local coordinates, the shooting angle and the angle of view which are included in the composition data are used. Next, coordinate transformation is performed to transform shooting-position data (longitude, latitude, and altitude) included in the composition data into world coordinates.

The world coordinates are coordinates defined by longitude and latitude information of a GPS. Next, the world coordinates are transformed into view coordinates, since the virtual objects are viewed from the viewpoint of an individual. The attitude, position, and azimuth of the image capture apparatus 20 may be defined to transform the world coordinates into the view coordinates. As a result of the transformation into the view coordinates, the image capture apparatus 20 is located at the coordinate origin.

Since the angle of view changes according to zooming or the like, the image capture apparatus 20 is adapted to transform the view coordinates into perspective coordinates on the basis of the angle-of-view information. A method for the coordinate transformation may be implemented by parallel projection or perspective projection. The transformation of the view coordinates into the perspective coordinates means that a 3D object is transformed into a 2D object.

In addition, in order to match the display screen with the screen of the LCD 30 of the image capture apparatus 20, the perspective coordinates are transformed into display coordinates corresponding to the display screen size (e.g., 480×640). Thus, the virtual objects constituted by the frame and the pin are displayed on the screen of the LCD 30 of the image capture apparatus 20 in accordance with the current position, attitude, and azimuth, and angle of view of the image capture apparatus 20.

The display transformation may be accomplished by not only the above-described viewing-pipeline processing but also other processing that can display a 3D virtual object on the screen of a 2D display device by changing the shape and the position of the 3D virtual object in accordance with the current position, attitude, azimuth, and angle of view of the image capture apparatus 20.

### Flow of Processing

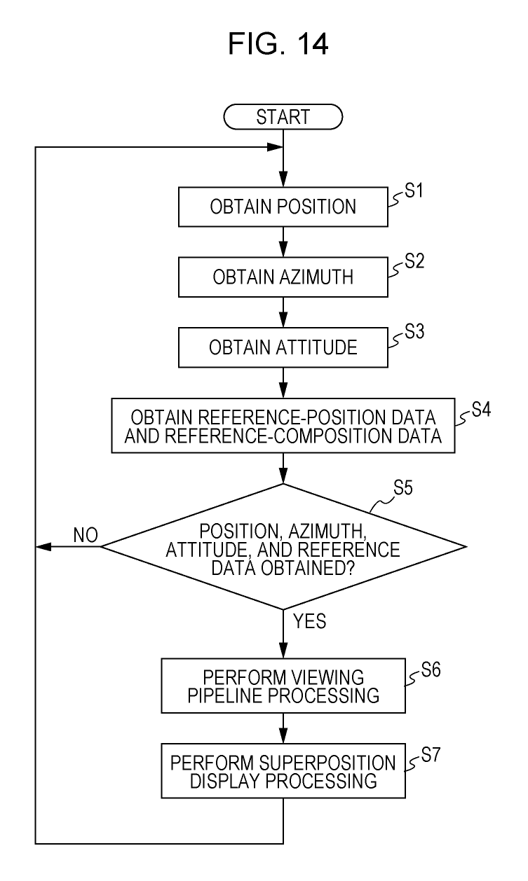

In the present disclosure, the processing is performed as illustrated in the flowchart in FIG. 14. The processing below may be performed by the AR display control section 56 (see FIG. 3). In step S1, the position detector 71 obtains the current-position data of the image capture apparatus 20. In step S2, the azimuth detector 72 obtains the current-azimuth data of the image capture apparatus 20. In step S3, the attitude detector 73 obtains the current-attitude data of the image capture apparatus 20. In step S4, reference data (reference-position data and reference-composition data) are obtained from the storage device 57.

In step S5, a determination is made as to whether or not the current position data, azimuth data, and attitude data of the image capture apparatus 20 and the reference data are obtained. When it is determined that all of the data are obtained, the process proceeds to step S6 in which the viewing-pipeline processing is performed. In the viewing-pipeline processing, display objects (e.g., the frame and the pin) are generated. In step S7, superimposition display processing is performed. The process then returns to step S1 and the processing in step S1 and the subsequent steps is repeated after a predetermined time passes.

In the present disclosure, in the procedure of the three steps including moving to the shooting point, determining the direction in which the image capture apparatus is aimed, and determining the angle of view by performing zoom adjustment and so on to perform shooting, the coherent user interface can provides intuitive guidance that is easy to understand for anyone. The user of the image capture apparatus can easily recognize a shooting point within sight by starting the image capture apparatus and viewing the scenery therethrough and also can intuitively understand the significance of moving to that point. Additionally, the frame indicating the composition for shooting is displayed in a three dimensional manner, so that the user can easily understand the direction in which a desirable composition for shooting can be obtained at the shooting point. Thus, even a user who is not good at taking a picture can take a picture with a preferable composition.

### Modifications

Although the embodiment of the present disclosure has been specifically described above, the present disclosure is not limited thereto and various modifications can be made based on the technical ideas of the present disclosure. For example, in the above-described embodiment, the pin indicating a position and the frame are used as display objects. However, any other mark that can give guidance for a composition for shooting may also be used. For example, a mark, such as a + (cross) or x, may be used. In addition, the subject for shooting is not limited to stationary scenery and may be a moving subject.

The configurations, the methods, the processes, the shapes, the materials, the numeric values, and so on in the above-described embodiment may be combined together without departing from the spirit and scope of the present disclosure.

Some embodiments may comprise a computer-readable storage medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage media) encoded with one or more programs (e.g., a plurality of processor-executable instructions) that, when executed on one or more computers or other processors, perform methods that implement the various embodiments discussed above. As is apparent from the foregoing examples, a computer-readable storage medium may retain information for a sufficient time to provide computer-executable instructions in a non-transitory form.

It should be understood by those skilled in the art that various modifications, combinations, sub-combinations and alterations may occur depending on design requirements and other factors insofar as they are within the scope of the appended claims or the equivalents thereof.

Use of ordinal terms such as “first,” “second,” “third,” etc., in the claims to modify a claim element does not by itself connote any priority, precedence, or order of one claim element over another or the temporal order in which acts of a method are performed. Such ordinal terms are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present disclosure contains subject matter related to that disclosed in Japanese Priority Patent Application JP 2011-176498 filed in the Japan Patent Office on Aug. 12, 2011, the entire contents of which are hereby incorporated by reference. In addition, the following configurations are included in the technical scope of the present disclosure.

(1) An image capture apparatus configured to obtain at least one image including a first image, the image capture apparatus comprising:

at least one processor configured to produce a first superimposed image by superimposing first navigation information with the first image at least in part by using first composition data associated with the first image and reference composition data associated with a reference image; and

at least one display configured to display the first superimposed image,

wherein the first composition data comprises shooting angle information and/or angle-of-view information of the image capture apparatus when the image capture apparatus obtained the first image.

(2) The image capture apparatus of (1), wherein the at least one image includes a second image, and wherein the at least one processor is further configured to:

produce a second superimposed image by superimposing second navigation information with the second image at least in part by using second composition data associated with the second image and the reference composition data, wherein the second navigation information is different from the first navigation information.

(3) The image capture apparatus of (1), wherein the first composition data associated with the first image comprises position information, shooting angle information, and angle-of-view information of the image capture apparatus obtained when the image capture apparatus obtained the first image.
(4) The image capture apparatus of (1), wherein the at least one processor is configured to superimpose the first navigation information by superimposing at least one virtual object with the first image.
(5) The image capture apparatus of (4), wherein the at least one processor is configured to superimpose the at least one virtual object by superimposing at least one virtual object having a size and an orientation that are determined based at least in part on the composition data.
(6) The image capture apparatus of (2), wherein the at least one processor is configured to:

superimpose the first navigation information at least by superimposing at least one virtual object with the first image; and

superimpose the second navigation information at least by superimposing at least another virtual object with the second image,

wherein the at least another virtual object has a size and an orientation that are determined based at least in part on the second composition data.

(7) The image capture apparatus of (1), wherein the at least one display is further configured to display the reference image concurrently with the first superimposed image.
(8) The image capture apparatus of (1), wherein the at least one display is further configured to display at least one cursor concurrently with the first superimposed image, wherein the at least one cursor is displayed so as to indicate a direction toward a position from which the reference image was obtained.
(9) The image capture apparatus of (1), wherein the image capture apparatus is a smart phone.
(10) A method for assisting a user obtain at least one image, including a first image, with an image capture apparatus, the method comprising:

producing, with the image capture apparatus, a first superimposed image by superimposing first navigation information with the first image at least in part by using first composition data associated with the first image and reference composition data associated with a reference image; and

displaying the first superimposed image,

wherein the first composition data comprises shooting angle information and/or angle-of-view information of the image capture apparatus when the image capture apparatus obtained the first image.

(11) The method of (10), wherein the at least one image includes a second image, and wherein the method further comprises:

producing a second superimposed image by superimposing second navigation information with the second image at least in part by using second composition data associated with the second image and the reference composition data, wherein the second navigation information is different from the first navigation information.

(12) The method of (10), wherein the first composition data associated with the first image comprises position information, shooting angle information, and angle-of-view information of the image capture apparatus obtained when the image capture apparatus obtained the first image.
(13) The method of (10), wherein superimposing the first navigation information comprises superimposing at least one virtual object with the first image.
(14) The method of (13), wherein superimposing the at least one virtual object comprises superimposing at least one virtual object having a size and an orientation that are determined based at least in part on the composition data.
(15) The method of (10), further comprising displaying the reference image concurrently with the first superimposed image or displaying at least one cursor concurrently with the first superimposed image, wherein the at least one cursor is displayed so as to indicate a direction toward a position from which the reference image was obtained.
(16) At least one computer-readable storage medium storing processor-executable instructions that, when executed by an image capture apparatus, cause the image capture apparatus to perform a method for assisting a user obtain at least one image including a first image, the method comprising:

producing, with the image capture apparatus, a first superimposed image by superimposing first navigation information with the first image at least in part by using first composition data associated with the first image and reference composition data associated with a reference image; and

displaying the first superimposed image,

wherein the first composition data comprises shooting angle information and/or angle-of-view information of the image capture apparatus when the image capture apparatus obtained the first image.

(17) The at least one computer-readable storage medium of (16), wherein the at least one image includes a second image, and wherein the method further comprises:

producing a second superimposed image by superimposing second navigation information with the second image at least in part by using second composition data associated with the second image and the reference composition data, wherein the second navigation information is different from the first navigation information.

(18) The at least one computer-readable storage medium of (16), wherein the first composition data associated with the first image comprises position information, shooting angle information, and angle-of-view information of the image capture apparatus obtained when the image capture apparatus obtained the first image.
(19) The at least one computer-readable storage medium of (16), wherein superimposing the first navigation information comprises superimposing at least one virtual object with the first image, the at least one virtual object having a size and an orientation that are determined based at least in part on the composition data.
(20) The at least one computer-readable storage medium of (16), wherein the method further comprises displaying the reference image concurrently with the first superimposed image or displaying at least one cursor concurrently with the first superimposed image, wherein the at least one cursor is displayed so as to indicate a direction toward a position from which the reference image was obtained.

1. An image capture apparatus configured to obtain at least one image including a first image, the image capture apparatus comprising:
at least one processor configured to produce a first superimposed image by superimposing first navigation information with the first image at least in part by using first composition data associated with the first image and reference composition data associated with a reference image; and
at least one display configured to display the first superimposed image,
wherein the first composition data comprises shooting angle information and/or angle-of-view information of the image capture apparatus when the image capture apparatus obtained the first image.

2. The image capture apparatus of claim 1, wherein the at least one image includes a second image, and wherein the at least one processor is further configured to:
produce a second superimposed image by superimposing second navigation information with the second image at least in part by using second composition data associated with the second image and the reference composition data, wherein the second navigation information is different from the first navigation information.

3. The image capture apparatus of claim 1, wherein the first composition data associated with the first image comprises position information, shooting angle information, and angle-of-view information of the image capture apparatus obtained when the image capture apparatus obtained the first image.

4. The image capture apparatus of claim 1, wherein the at least one processor is configured to superimpose the first navigation information by superimposing at least one virtual object with the first image.

5. The image capture apparatus of claim 4, wherein the at least one processor is configured to superimpose the at least one virtual object by superimposing at least one virtual object having a size and an orientation that are determined based at least in part on the composition data.

6. The image capture apparatus of claim 2, wherein the at least one processor is configured to:
superimpose the first navigation information at least by superimposing at least one virtual object with the first image; and
superimpose the second navigation information at least by superimposing at least another virtual object with the second image,
wherein the at least another virtual object has a size and an orientation that are determined based at least in part on the second composition data.

7. The image capture apparatus of claim 1, wherein the at least one display is further configured to display the reference image concurrently with the first superimposed image.

8. The image capture apparatus of claim 1, wherein the at least one display is further configured to display at least one cursor concurrently with the first superimposed image, wherein the at least one cursor is displayed so as to indicate a direction toward a position from which the reference image was obtained.

9. The image capture apparatus of claim 1, wherein the image capture apparatus is a smart phone.

10. A method for assisting a user obtain at least one image, including a first image, with an image capture apparatus, the method comprising:
producing, with the image capture apparatus, a first superimposed image by superimposing first navigation information with the first image at least in part by using first composition data associated with the first image and reference composition data associated with a reference image; and
displaying the first superimposed image,
wherein the first composition data comprises shooting angle information and/or angle-of-view information of the image capture apparatus when the image capture apparatus obtained the first image.

11. The method of claim 10, wherein the at least one image includes a second image, and wherein the method further comprises:
producing a second superimposed image by superimposing second navigation information with the second image at least in part by using second composition data associated with the second image and the reference composition data, wherein the second navigation information is different from the first navigation information.

12. The method of claim 10, wherein the first composition data associated with the first image comprises position information, shooting angle information, and angle-of-view information of the image capture apparatus obtained when the image capture apparatus obtained the first image.

13. The method of claim 10, wherein superimposing the first navigation information comprises superimposing at least one virtual object with the first image.

14. The method of claim 13, wherein superimposing the at least one virtual object comprises superimposing at least one virtual object having a size and an orientation that are determined based at least in part on the composition data.

15. The method of claim 10, further comprising displaying the reference image concurrently with the first superimposed image or displaying at least one cursor concurrently with the first superimposed image, wherein the at least one cursor is displayed so as to indicate a direction toward a position from which the reference image was obtained.

16. At least one computer-readable storage medium storing processor-executable instructions that, when executed by an image capture apparatus, cause the image capture apparatus to perform a method for assisting a user obtain at least one image including a first image, the method comprising:
producing, with the image capture apparatus, a first superimposed image by superimposing first navigation information with the first image at least in part by using first composition data associated with the first image and reference composition data associated with a reference image; and
displaying the first superimposed image,
wherein the first composition data comprises shooting angle information and/or angle-of-view information of the image capture apparatus when the image capture apparatus obtained the first image.

17. The at least one computer-readable storage medium of claim 16, wherein the at least one image includes a second image, and wherein the method further comprises:
producing a second superimposed image by superimposing second navigation information with the second image at least in part by using second composition data associated with the second image and the reference composition data, wherein the second navigation information is different from the first navigation information.

18. The at least one computer-readable storage medium of claim 16, wherein the first composition data associated with the first image comprises position information, shooting angle information, and angle-of-view information of the image capture apparatus obtained when the image capture apparatus obtained the first image.

19. The at least one computer-readable storage medium of claim 16, wherein superimposing the first navigation information comprises superimposing at least one virtual object with the first image, the at least one virtual object having a size and an orientation that are determined based at least in part on the composition data.

20. The at least one computer-readable storage medium of claim 16, wherein the method further comprises displaying the reference image concurrently with the first superimposed image or displaying at least one cursor concurrently with the first superimposed image, wherein the at least one cursor is displayed so as to indicate a direction toward a position from which the reference image was obtained.
